(19) United States
(12) Patent Application Publication
(10) Pub. No.: US 2026/0180208 A1
(43) Pub. Date: Jun. 25, 2026

(54) ELECTRICAL CONNECTION ASSEMBLY HAVING AN OVERHEAT DETECTOR FOR THE PREVENTION OF THE GENERATION OF AN ELECTRIC ARC

(71) Applicant: Airbus Operations (S.A.S.), Toulouse (FR)

(72) Inventor: Franck Albero, Toulouse (FR)

(21) Appl. No.: 19/414,725

(22) Filed: Dec. 10, 2025

(30) Foreign Application Priority Data
Dec. 19, 2024 (FR) FR2414605

(51) Int. Cl. H01R 4/34

(52) U.S. Cl. CPC H01R 4/34; H01R 2201/26

(57) ABSTRACT

An electrical connection assembly to establish a connection between the terminal elements of electrical conductors which are fitted with terminal rings and including a thermo-deformable element configured to undergo strain as a function of the temperature of the connection assembly, such that an electrical contact between two electrical contact elements is established or interrupted. It is possible to execute detection of conditions for initiation of an electric arc or the presence of a continuous or intermittent electric arc in the connection assembly, by reference to the heat-up of the thermo-deformable element associated with the initiation or the presence of an electric arc.

### TECHNICAL FIELD

The disclosure herein relates to an electrical connection assembly, particularly of the lug connector type, which assembly is configured for detecting an electrical continuity fault of the type which might generate a heat-up resulting in an electric arc. At least one embodiment relates to an electrical connection assembly for an aircraft electric circuit.

### BACKGROUND

Aircraft architectures are evolving, and aircraft are increasingly being electrified by the introduction of high-voltage direct current systems, frequently described as “HVDC” (the English acronym for “High Voltage Direct Current”) or “CCHT” (the French acronym for “Courant Continu Haute Tension”). The introduction of electrical systems of this type on board aircraft is associated with disadvantages, such as the potential occurrence of serial electric arcing. In the case of direct current, as the voltage has no zero-crossing, an electric arc may be sustained for substantially longer than in the case of an alternating current, in which zero-crossings execute a self-quenching function. This applies particularly to connections of the bolted lug type, which are preferred for the establishment of connections in a high-current electrical line. In practice, in the event of incorrect tightening, a loose connection, an excessive contact resistance or the incorrect crimping of a lug, a hotspot can occur, which hotspot is a precursor to an electric arc. Although monitoring techniques exist, which techniques involve temperature sensors or optical fibres which are connected to a receiver, these solutions involve numerous elements, and are thus punitive in terms of weight and an increased complexity of circuits. Moreover, these detection systems can be affected by defects and spurious detections, thereby reducing the overall reliability of the system.

This situation is susceptible to improvement.

### SUMMARY

One object of the disclosure herein is the proposal of an electrical connection assembly involving the tightening of terminal ring connection elements on a stud which is fitted with an overheat detector, which overheat is a precursor to a continuous or intermittent electric arc.

To this end, an electrical connection assembly is proposed, which assembly comprises a stud which is rigidly attached to a support, and a threaded element of which projects from the support, wherein the stud comprises a head which projects at an opposing side of the support vis-à-vis the thread, wherein the design of the assembly is configured such that a nut which is fitted to the thread is able to clamp one or more terminal rings between the support and the nut, wherein the connection assembly is designed such that:
at least one first electrically conductive and thermo-deformable electrical contact element is electrically connected to the stud, and is arranged on the head of the stud vis-à-vis a second electrical contact element which is connected to an equipotential reference source, and
the first, thermo-deformable electrical contact element is configured to be electrically isolated from the second electrical contact element, in the event that the temperature thereof is lower than a predetermined threshold value, and to be electrically connected to the second electrical contact element, in the event that the temperature thereof is greater than or equal to a predetermined threshold value, or vice versa.

Accordingly, thermomechanical strain of the first electrical contact element originating from an increase in temperature associated with a deterioration of electrical contact, and potentially resulting in the presence of a continuous or repetitive electric arc, advantageously leads this first electrical contact element into contact with the second electrical contact element, which contact element is connected to an equipotential reference source, or removes this first electrical contact element from the second electrical contact element, which contact element is connected to an equipotential reference source, which lead-in or removal respectively constitute a closing or an opening of a switch between the connection point (in this case, the stud) of the connection assembly and the equipotential reference source, which may be connected to ground or to an electrical reference potential. Advantageously, an operation of this type enables the subsequent execution of a detection of a change in the state of the electrical line concerned, by remote facilities which are connected to the line, including, for example, an impedance measurement device, a voltage measurement device, or any other device which is configured to execute monitoring functions on the electric power supply line to which it is connected.

The electrical connection assembly according to the disclosure herein can moreover assume the following additional characteristics, considered individually or in combinations.

The electrical connection assembly comprises a single first thermo-deformable electrical contact element, which contact element comprises an electrical resistance, or is coupled to an electrical resistance which is arranged electrically in series between the head of the stud and a point on the first electrical contact element which is intended to engage in contact with the second electrical contact element.

The electrical connection assembly comprises a plurality of first electrical contact elements, which contact elements are respectively thermo-deformable in accordance with mechanical strain characteristics, according to the mutually differing temperature thereof, and each of which comprises an electrical resistance or is coupled to an electrical resistance which is arranged electrically in series between the head of the stud and a point on the first electrical contact element which is putatively intended to engage in contact with the second electrical contact element, wherein each of the electrical resistances thus assumes an electrical resistance value which differs from that of the other electrical resistances.

The electrical connection assembly comprises at least one first electrical contact element which is associated (combined) with a non-return mechanism, which mechanism is configured to lock the first electrical contact element in a position of electrical contact with the second electrical contact element with which it cooperates.

A further object of the disclosure herein is a connection terminal block comprising a plurality of electrical connection assemblies according to the above-mentioned electrical connection assembly.

A further object of the disclosure herein is an electric circuit comprising at least one electrical connection assembly of the above-mentioned type, and an electric circuit monitoring devices which is connected to the connection assembly.

Finally, the object of the disclosure herein is an aircraft comprising an electrical connection assembly of the above-mentioned type, or a terminal block of the above-mentioned type, or an electric circuit of the above-mentioned type.

### BRIEF DESCRIPTION OF THE DRAWINGS

FIG. 1 shows a schematic illustration of an electrical connection assembly according to one embodiment, in the absence of an electric arc;

FIG. 2 shows a schematic illustration of the electrical connection assembly represented according to FIG. 1, which assembly is employed for executing a connection between two electrical conductors having terminations of the terminal ring type, in the absence of an electric arc;

FIG. 3 shows a schematic illustration of the electrical connection assembly represented according to FIG. 1, which assembly assumes a thermomechanical deformation of an electrical contact element, in the presence of an overheat associated with an impaired electrical contact, and potentially resulting in the generation of an electric arc;

FIG. 4 shows a schematic illustration of a first variant of the electrical connection assembly represented according to FIGS. 1 to 3;

FIG. 5 shows a schematic illustration of a second variant of the electrical connection assembly represented according to FIGS. 1 to 3;

FIG. 6 shows a schematic illustration of a third variant of the electrical connection assembly represented according to FIGS. 1 to 3;

FIG. 7 shows an illustration of an electric circuit comprising two connection assemblies according to one embodiment, and an electric power supply line monitoring device;

FIG. 8 shows a schematic illustration of an aircraft having at least one electrical connection assembly according to one embodiment; and

FIG. 9 illustrates an exemplary internal architecture of an electric power supply line monitoring device represented in FIG. 7.

### DETAILED DESCRIPTION

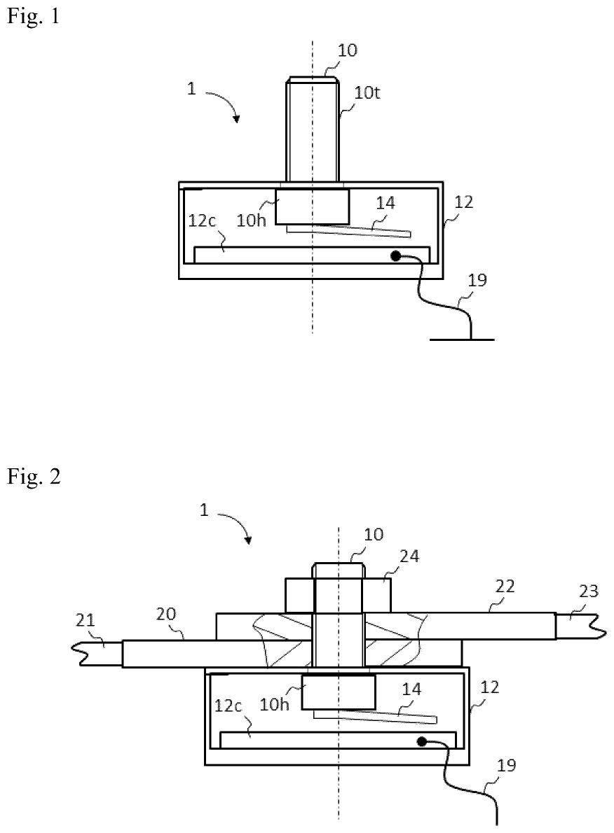

FIG. 1 shows a schematic representation of an electrical connection assembly 1 which is appropriate for the interconnection of electrical conductors which are fitted with terminal elements of the lug type, in particular with terminal rings. The connection assembly 1 comprises an electrically conductive stud 10, which stud is integrally mounted in a support (or a base, or baseplate) 12, and having a threaded section which is provided with a thread 10t, which section projects from the support 12. The support 12 is electrically insulating. The stud 10 moreover comprises a stud head 10h (or a shoulder 10h) which is rigidly attached to the support 12, and which projects at an opposing side of the support 12, vis-à-vis the threaded section of the stud 10. The arrangement enables the clamping of electrical connection lugs around the threaded section of the stud 10, wherein the lugs are gripped between the support 12 and a clamping nut having a tapped thread which is complementary to the thread 10t, which nut is fitted to the stud 10. A first electrical contact element 14 integrally mounted on the head of the stud 10h. The first electrical contact element 14 is thermo-deformable, i.e. undergoes progressive strain as a function of variations in the temperature thereof, according to a predefined strain curve. According to one embodiment, the first electrical contact element 14 is a bilaminar element which curves progressively as the temperature thereof rises. The support 12 which, according to the example illustrated, assumes a hollow shape, moreover comprises a second electrically conductive electrical contact element 12c, and assumes a connection point to an electric equipotential reference source 19. According to one embodiment, the first thermo-deformable electrical contact element 14 and the second electrical contact element 12c are arranged in mutual opposition such that, when the strain of the first electrical contact element 14 exceeds a certain level, in the event that the temperature thereof exceeds a temperature threshold value, the end of the first electrical contact element 14 engages in mechanical contact with the second electrical contact element 12. The two electrical contact elements 14 and 12c thus function in combination as a normally open contactor, operating in accordance with the temperature of the first electrical contact element. According to one variant of embodiment, the first thermo-deformable electrical contact element 14 and the second electrical contact element 12c are arranged in mutual opposition such that, when the strain of the first electrical contact element 14, which contact element is initially in mechanical contact with the second contact element 12c, exceeds a certain level, in the event that the temperature thereof exceeds a temperature threshold value, the end of the first electrical contact element 14 disengages from the second electrical contact element 12. The two electrical contact elements 14 and 12c thus function in combination as a normally closed contactor, operating in accordance with the temperature of the first electrical contact element 14.

Astutely and advantageously, by the above-mentioned arrangement of the electrical connection assembly 1, it is possible to detect the presence of precursors to, or confirmatory signs of a continuous or recurrent electric arc on the stud 10, as the presence or initiation of an electric arc induces a rise in the temperature of the stud 10, which rise in temperature is propagated in the first electrical contact element 14. A monitoring device 17 of the electrical line (not represented in FIG. 1, but visible in FIG. 7), connected between the stud 10 of the connection assembly 1 and the equipotential reference source 19, thus has the capacity to detect a short-circuit between these two equipotential elements, or at least to detect a reduced or highly reduced resistance level.

FIG. 2 shows a partial sectional illustration of the connection assembly 1, at which and by which two terminal rings 20 and 22 are interconnected, which rings are respectively connected to electrical conductors 21 and 23. The terminal rings are arranged in a manner which enables the traversal thereof by the stud 10, and are clamped between the surface of the support 12 from which the stud 10 projects, and a nut 24 having a thread which is complementary to a thread 10t on the stud 10, and which is tightened on the stud 10. The electrical connection assembly 1 is represented here in the absence of a source of heat-up, such as an electric arc, and the first electrical contact element 14 is in a resting state, in the absence of any strain of thermal origin.

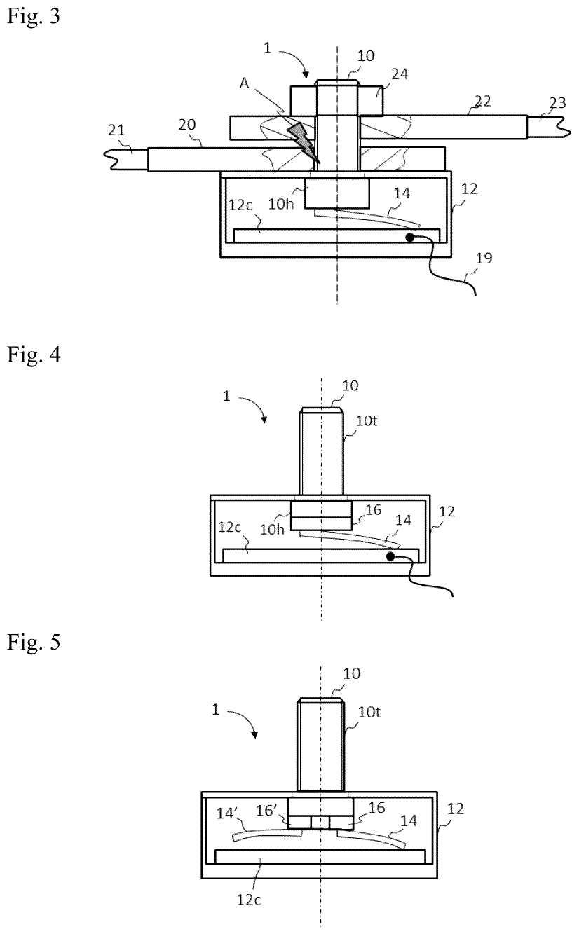

FIG. 3 illustrates the electrical connection assembly 1 which executes the electrical connection previously represented in FIG. 2 but, in this case, subject to a heat-up which might potentially result in the generation of an electric arc A, the origin of which is exemplarily attributable to a defective tightening of the nut 24 on the stud 10, thus resulting in the presence of a variable air gap between the terminal rings 20 and 22. According to the configuration illustrated in FIG. 3, the electric arc A is an electric arc, the frequency of occurrence of which generates a rise in the temperature of elements in proximity thereto and, by conduction via the head of the stud 10h, of the first electrical contact element 14, which element is of the bilaminar type, and which thus undergoes sufficient strain to engage in mechanical and electrical contact, at least at one predetermined point of contact, with the second electrical contact element 12c, which element is connected to the equipotential reference source 19.

FIG. 4 illustrates a first variant of embodiment of the electrical connection assembly 1, according to which a resistive element 16 (an electrical resistance) is electrically incorporated in series between the head 10h of the stud 10 and the first electrical contact element 14 such that, where the first electrical contact element 14 undergoes strain, and functions as a closed contactor in combination with the second electrical contact element 12c, the electrical resistance 16 is electrically incorporated between the stud 10 and the equipotential reference source 19. A first advantage proceeds from the current limitation associated with the presence of the resistive element 16. A second advantage is provided, in that it is possible to dissociate two electrical connection assemblies which are embodied according to the principle of the electrical connection assembly 1, but which are respectively provided with resistive elements (such as element 16) of different electrical resistance ratings. For example, a first electrical connection assembly can comprise a resistive element having an electrical resistance of 5,000 ohms, and a second resistive element can comprise a resistive element having an electrical resistance of 6,000 ohms.

FIG. 5 illustrates a second variant of embodiment of the electrical connection assembly 1, according to which the electrical connection assembly 1 comprises a plurality of first thermo-deformable electrical contact elements, according to the type of element 14. According to the example illustrated in FIG. 5, two first elements 14 and 14′ are arranged on the head of the stud 10h or, more specifically, on the two resistive elements 16 and 16′ to which they are respectively fitted, in opposition to the second electrical contact element 12c.

In the present context, the term “first elements” describes thermo-deformable contact elements, by way of distinction from one or more “second elements”, which elements are non-thermo-deformable contact elements, with which the first elements engage in contact further to the sufficient strain thereof, and in accordance with the specific calibration thereof. According to one embodiment, each of the first thermo-deformable elements 14 and 14′ assumes a different characteristic of mechanical strain (calibration), according to temperature, such that one of the first electrical contact elements 14 and 14′ engages in contact with the second electrical contact element 12c, whereas the other of the first electrical contact elements 14 and 14′ has yet to undergo sufficient strain, in response to a rise in temperature, to engage in mechanical contact with the second electrical contact element 12c. It is thus advantageously possible to execute the detection of an electric arc by degrees or stages of temperature, and thus to detect the severity or damage potential associated therewith. The example described here is not provided by way of limitation, and it is possible to arrange a higher number of first electrical contact elements, which elements are similar to element 14, for example arranged radially on the head of the stud 10h, and uniformly radially distributed about the latter. Moreover, each of the first electrical contact elements 14 and 14′ can be associated with a resistive element of a different rating which is electrically arranged in series therewith, such that it is possible to indicate to a remote monitoring device which of the first thermo-deformable elements is in mechanical contact with the second contact element 12c, by the detection of the resistive value thereof in the closed electric circuit.

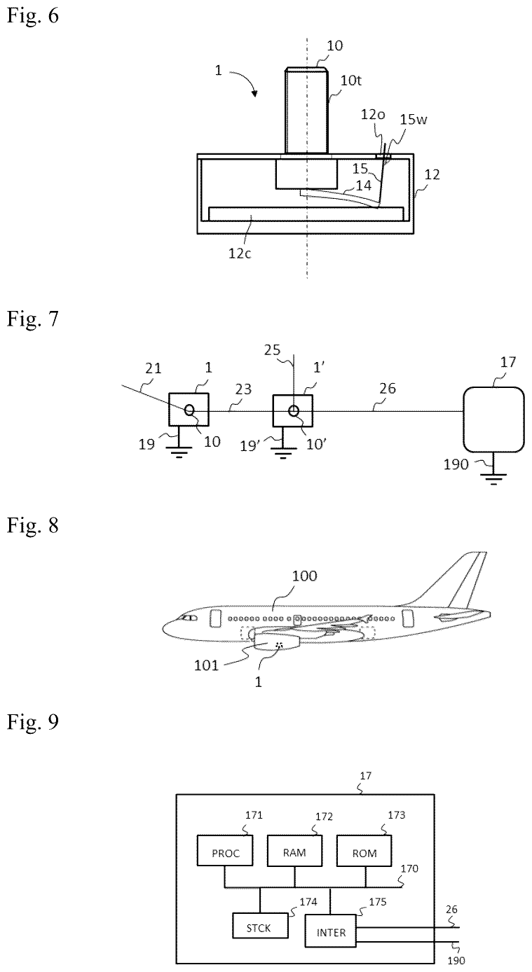

FIG. 6 illustrates a third variant of the electrical connection assembly 1, according to which the thermo-deformable first electrical contact element 14 is provided with a locking system in the event of the activation thereof, which system enables the memorization of the occurrence of a fault, further to the potential clearance of this fault. The locking system exemplarily comprises a rod 15 which is coupled to the first element 14, and which is designed to execute a translational motion through an opening 12o which is formed in the support 12, which stem 15 is provided with a non-return locking lug 15w which is designed to engage with a peripheral support surface 12 to the opening 12o (at the edge of the opening 12o). According to one embodiment, the rod 15 is also a thermo-deformable element of a specific form, for the generation of a spring action and the exertion of pressure on the first electrical contact element 14 further to cooling, thus ensuring a continuity of mechanical and electrical contact between the electrical contact elements 14 and 12c. Naturally, this form of implementation, in the present context, is provided by way of an illustrative example only, and numerous other forms of locking systems can be implemented. According to one embodiment, part of the rod 15 which projects out of the support 12, via the opening 12a, prior to activation and which, further to activation, no longer projects, in the event that the locking system is operational, functions as a visual indicator of activation. According to one variant of embodiment, a substantial portion of the rod 15 projects, prior to activation, and only a small portion of the rod 15 projects after activation, thus enabling the manipulation of the remaining visible portion for the execution of a release of the locking system illustrated. More generally, the electrical connection assembly 1 can comprise an automatic locking system, in the activated position, and a manual or remotely controlled release system, thus enabling the “resetting” of the electrical connection assembly to the functional configuration which was in force prior to the occurrence of a temperature fault (for example in the presence of an electric arc).

FIG. 7 shows a schematic illustration of an electric power supply line comprising three electrical conductors 21, 26 and 23, which conductors are assembled by two electrical connection assemblies, one of which is the electrical connection assembly 1 comprising the stud 10, and the other of which is an electrical connection assembly 1′ comprising a stud 10′, which assembly is similar to the connection assembly 1, with the exception that it comprises a resistive element arranged in series with the thermo-deformable element thereof, and having a resistance rating which differs from that of a resistive element which assumes the same function in the connection assembly 1. The equipotential reference source 19 of the connection assembly 1 is connected to an electrical ground, and the equipotential reference source 19′ of the connection assembly 1′ is also connected to an electrical ground. An electronic monitoring device 17 of one or more electric power supply lines is moreover connected at one point of the electric power supply line of the electrical conductor 26. The monitoring device 17 comprises an equipotential reference source 190, which source is also connected to an electrical ground.

According to the example described, the electric power supply line illustrated is an electric power supply line which supplies a direct current on board an aircraft. According to variants, the equipotential reference sources 19, 19′ and 190 might be connected to a common equipotential reference source other than ground.

Advantageously, in the event of heat-up at the interconnection of the electrical conductors 21 and 23, localized heat-up generates a rise in the temperature of the stud 10 of the connection assembly 1. This rise in temperature is propagated to the first thermo-deformable electrical contact element 14, which element is calibrated to undergo sufficient strain, in excess of a temperature threshold value, to engage in contact with the second electrical contact element 12c, which contact generates a connection of the resistive element 16 of the electrical connection assembly 1, between the conductor 23 and ground. The monitoring device 17 of the electrical line thus assumes a detection capacity, and detects a fault. For example, the monitoring device 17 measures the voltage level which is applied to the electrical conductor 26, and is capable of determining the value of the resistance which is incorporated in the circuit. Accordingly, the monitoring device 17 is not only capable of detecting the presence of a fault of electrical origin, but also of locating the source thereof in the aircraft, on the basis of the measured voltage level, in the event that each of the electrical connection assemblies provided assumes a resistance value which differs from that of the other resistances which are respectively fitted to the one or more other electrical connection assemblies which are similar to the electrical connection assembly 1, such as the electrical connection assembly 1′.

FIG. 8 shows a schematic illustration of an aircraft 100 comprising the electric power supply line which is schematically represented in FIG. 7. The aircraft thus comprises the electrical connection assembly 1, which assembly advantageously enables the mitigation of inherent disadvantages associated with the occurrence of a hotspot or an electric arc in the event of a defective tightening of an electrical connection which is established by the electrical connection 1. Advantageously, very high numbers of the above-mentioned electrical connection assemblies can be employed for the equipment of systems in the aircraft 1.

FIG. 9 shows a schematic illustration of an exemplary internal architecture of the monitoring device 17 of the electric power supply line of the aircraft 1.

According to the hardware architecture represented in FIG. 9, the monitoring device 17 of the electric power supply line thus comprises the following, connected by a communication bus 170: a processor or CPU (Central Processing Unit) 171; a live RAM (Random Access Memory) 172; a non-volatile ROM (Read Only Memory) 173; a storage unit such as a hard disk (or a storage medium reader, such as a SD (Secure Digital) card reader 174; a power and communication interface module 175 which module enables the monitoring device 17 of the electric power supply line to communicate with remote devices, such as sensors or actuators, particularly including one or more electrical connection assemblies which are similar to the electrical connection assembly 1 or 1′.

The processor 171 of the monitoring devices 17 is capable of executing instructions which are loaded in the RAM 147 from the ROM 173, from an (unrepresented) external memory, from a storage medium (such as a SD card), or from a communication network. When the monitoring device 17 is powered-up, the processor 171 is capable of reading and executing instructions from the RAM 172. These instructions form a computer program which initiates the deployment, by the processor 171 of the device 17, of all or part of a process for monitoring the state of at least one electric power supply line, particularly on the basis of information obtained from one or more electrical connection assemblies.

All or part of a process of this type for monitoring the state of an electric power supply line can thus be implemented, in software form, by the execution of a series of instructions by a programmable machine, for example a DSP (Digital Signal Processor) or a microcontroller or, in hardware form, by a machine or a dedicated component, for example a FPGA (Field-Programmable Gate Array) or an ASIC (Application-Specific Integrated Circuit). In general, the monitoring device 17 of one or more electric power supply lines comprises electronic circuitry which is configured for the deployment of an electric power supply line monitoring process. Naturally, the monitoring device 17 moreover comprises or is coupled to all elements which are customarily present in an electronic system which comprises a control unit and associated peripherals, including a power supply circuit, a power supply monitoring circuit, one or more clock circuits, a reset circuit, input-output ports, switching inputs and bus drivers, wherein this list is not exhaustive.

Advantageously, by the above-mentioned electrical connection assembly, it is possible to detect the presence of heat-up which is a precursor to an electric arc and, if necessary, to isolate the electrical line concerned, in order to prevent or restrict damage to this electrical line or to its surroundings.

The disclosure herein is not exclusively limited to the examples and embodiments described, but is more generally applicable to any electrical connection device having a stud or bolt which is provided with a thermo-deformable element, which element is designed such that a heat-up of the stud or bolt which is provided by way of a retaining element results in a strain of the thermo-deformable element, which element thus functions as an opening or closing contactor of an electric circuit. In particular, the disclosure herein is applicable to a variety of electrical distribution systems including, for example, direct current or alternating current systems.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An electrical connection assembly comprising:
a stud which is rigidly attached to a support and a thread of which projects from the support, the stud comprising a head which projects at an opposing side of the support vis-à-vis the thread, wherein the assembly is configured such that a nut which is fitted to the thread is able to clamp one or more terminal rings between the support and the nut;
wherein at least one first electrically conductive and thermo-deformable electrical contact element is electrically connected to the stud, and is on the head of the stud vis-à-vis a second electrical contact element which is connected to an equipotential reference source; and
wherein the first thermo-deformable electrical contact element is configured to be electrically isolated from the second electrical contact element in an event that a temperature thereof is lower than a predetermined threshold value, and to be electrically connected to the second electrical contact element, in an event that a temperature thereof is greater than or equal to a predetermined threshold value, or vice versa.

2. The electrical connection assembly according to claim 1, comprising a single first thermo-deformable electrical contact element, wherein the contact element comprises an electrical resistance, or is coupled to an electrical resistance which is arranged electrically in series between the head of the stud and a point on the first electrical contact element which is intended to engage in contact with the second electrical contact element.

3. The electrical connection assembly according to claim 1, comprising a plurality of first electrical contact elements which are respectively thermo-deformable in accordance with mutually differing strain characteristics, and each of which comprises an electrical resistance or is coupled to an electrical resistance which is arranged electrically in series between the head of the stud and a point on the first electrical contact element which is putatively intended to engage in contact with the second electrical contact element, wherein each of the electrical resistances thus assumes an electrical resistance value which differs from that of other electrical resistances.

4. The electrical connection assembly according to claim 1, wherein at least one first electrical contact element is associated with a non-return mechanism which is configured to lock the first electrical contact element in a position of electrical contact with the second electrical contact element.

5. A connection terminal block comprising a plurality of electrical connection assemblies according to claim 1.

6. An electric circuit comprising the electrical connection assembly according to claim 1, and an electric circuit monitoring device which is electrically connected to the electrical connection assembly.

7. An aircraft comprising the electrical connection assembly according to claim 1.

8. An aircraft comprising the terminal block according to claim 5.

9. An aircraft comprising the electric circuit according to claim 6.
